(19) United States
(12) Patent Application Publication
(10) Pub. No.: US 2023/0169330 A1
(43) Pub. Date: Jun. 1, 2023

(54) SYSTEM AND METHOD FOR RECOMMENDING CONTENTS BASED ON DEEP NEURAL NETWORK

(71) Applicant: TVSTORM CO., LTD., Seoul (KR)

(72) Inventors: Hyeonwoo AN, Yongin-si (KR); DaeYeol KIM, Seoul (KR); Kwangkee LEE, Seongnam-si (KR)

(21) Appl. No.: 17/564,189

(22) Filed: Dec. 28, 2021

(30) Foreign Application Priority Data
Nov. 29, 2021 (KR) 10-2021-0166376

(51) Int. Cl. G06N 3/08; G06N 5/02

(52) U.S. Cl. CPC G06N 3/08; G06N 5/02

(57) ABSTRACT

The present inventive concept relates to a deep neural network-based contents recommendation system and method, wherein a server and a client terminal share a learning function and a recommendation function, respectively, and drafted data for contents and user are respectively generated according to the property of contents and user preference property for the contents, thus relating to a system and method for providing a personalized contents recommendation service in consideration of both contents and user properties by utilizing the generated each of the drafted data.

### FIELD

The present disclosure relates to a deep neural network-based contents recommendation system and method, wherein a server and a client terminal share a learning function and a recommendation function, respectively, and drafted data for contents and user are respectively generated according to the property of contents and user preference property for the contents, thus relating to a system and method for providing a personalized contents recommendation service in consideration of both contents and user properties by utilizing the generated each of the drafted data.

### BACKGROUND

Recently, as an OTT (over the top) service that provides contents based on the Internet has been rapidly grown, public interest for a personalized contents recommendation system is ever increasing.

The OTT service refers to a user-oriented service that enables users to consume desired contents through various terminals anytime, anywhere, wherever the Internet connection is available.

Since the contents recommendation system performs an important function of inducing users to continuously use the OTT service and continuously consume contents through contents recommendation, the contents recommendation system should be essential for the OTT service.

It is very important for such a contents recommendation system to provide customized contents by considering both the properties of the contents and the preference of the user.

Typically, there is a deep neural network-based recommendation system that recommends contents using a learning model created by learning the interactions (e.g., reviews or evaluation scores, etc.) between users and contents through a deep neural network.

In a deep neural network-based recommendation system, the design of an appropriate input to the learning model is very important in terms of accuracy and reflection of complex user preferences. Because training a target of the learning model depends on the input, the more closely the input is related to the goal, the less the learning model needs to train unnecessary information.

In other words, the size of the learning model is related to the amount required to train the non-linear transformation between the input and the target, and the more the input is related to the target and the more information it explains, the more suitable the learning model can be trained with a smaller size.

However, since a conventional deep neural network-based recommendation system uses only the action record between the user and the contents, there is a problem in that the size of the learning model becomes large or complicated as the training is performed only with scarce information.

Furthermore, a conventional deep neural network-based recommendation system is limited to the behavioral record between the user and the contents and tends to generalize the complex user preferences, so there is a limitation in recommending contents tailored to the actual user preferences.

In addition, a conventional deep neural network-based recommendation system has a problem in that when a new contents is added, there is no action record between the new contents and the user, so that the new contents cannot be recommended at all.

In addition, in the case of a conventional deep neural network-based recommendation system, the larger the learning model size, the more dependent on performance of the device, a set-top box or a mobile device with significantly lower performance than a computer is mainly used in the OTT environment. Therefore, the conventional deep neural network-based recommendation system is inevitably implemented in the form of central processing in which the server fully bears all the load.

As the number of users increases, because processing for all users must be centrally performed in the server, there is a problem in that the quality of the recommendation service remarkably deteriorates and performance close to real-time cannot be guaranteed.

Accordingly, the present inventive concept proposes a method for distributing a training function and a recommendation function to a contents recommendation server and a contents recommendation client for the purpose of distributing the load of the contents recommendation server.

In addition, the present inventive concept proposes a method for generating contents drafted data and user drafted data, respectively, according to the properties of the contents and user preference properties and providing personalized contents recommendation service considering both the contents and the user properties by using the training result and each drafted data.

Hereinafter, the prior art existing in the technical field of the present inventive concept will be briefly described, and then the technical matters that the present inventive concept intends to achieve differently from the prior arts will be described.

First, Korean Patent Registration No. 2250135 B1 (2021.05.03.) relates to a method for providing a recommended video and an apparatus therefor, receiving a plurality of video contents from an OTT server, determining the ranking of the plurality of contents according to the total cumulative number of views of the plurality of video contents, the cumulative number of views within last n months, and related corporative companies, and then making the contents exposed to a terminal in the order of the highest ranking.

That is, KR 2250135 B1 relates to recommend high-ranking contents to the terminal by simply determining the ranking of a plurality of contents according to the cumulative number of views.

On the other hand, the present inventive concept provides a personalized recommendation service according to the properties of the contents and the user preference properties, and thus KR 2250135 B1 fails to describe or suggest the technical features of the present inventive concept.

In addition, Korean Patent Registration No. 2137887 B1(2020.07.20.) relates to a server and method for recommending IPTV video VOD contents through combining a mobile OTT service among IPTV services and a movie VOD preference information, wherein this prior art collects preference data for each of VOD contents viewed through IPTV and OTT, integrates each of the collected preference data, calculates the predicted preference of VOD contents related to the user, and then recommends a VOD contents. Wherein the preference data in KR 2137887 B1 means a preference for a genre of VOD contents viewed by the user.

That is, KR 2137887 B1 processes the preference data for genres of VOD contents viewed by all users in the recommendation server, so the load is concentrated on the recommendation server as the number of users increases, and thus there is a problem in that the quality of the recommendation service significantly decreases.

On the other hand, the present inventive concept makes the training and contents recommendation performed to be divided into a server and a client, and thus a centralized load is distributed as well as a personalized recommendation service can be provided by allowing each client to recommend contents for an individual user according to the training result performed by the server. Therefore, there is a significant difference in technical features between the present inventive concept and KR 2137887 B1.

### SUMMARY

The present disclosure is invented to solve the above-mentioned problems, and it is objective for the present inventive concept to provide a contents recommendation system and method based on a deep neural network that distributes the system load for contents recommendation by dividing the training and contents recommendation for individual users into a contents recommendation server and a contents recommendation client, respectively.

In addition, it is an objective for the present inventive concept to provide a deep neural network-based contents recommendation system and method for providing a personalized/customized contents recommendation service in consideration of both the properties of contents and the users by using drafted data on the properties of the contents and the preference properties of the users.

In addition, it is an objective for the present inventive concept to provide a deep neural network-based contents recommendation system and method for performing training for the entire learning models including the server model including an encoder using contents drafted data and user drafted data for a plurality of users in a contents recommendation server, and a client model including a decoder and user preference prediction model, and for providing a training result for a client model to a contents recommendation client.

In addition, it is an objective for the present inventive concept to a deep neural network-based contents recommendation system and a method therefor for extracting contents features for a plurality of contents by inputting contents drafted data for a user into an encoder in a contents recommendation server and providing a personalized contents recommendation service by using the user drafted data for the user and the contents features in the contents recommendation client.

In addition, it is an objective for the present inventive concept to a deep neural network-based contents recommendation system and method for restoring contents drafted data by inputting contents features to a decoder in a contents recommendation client, predicting user preferences for a plurality of contents using the restored contents drafted data and user drafted data, and recommending contents according to the predicted user preferences.

In addition, it is an objective of the present inventive concept to provide a deep neural network-based contents recommendation system and method for predicting user preferences for a plurality of contents by inputting restored contents drafted data and user drafted data to a client model in a contents recommendation client.

As described above, the present inventive concept of the deep neural network-based contents recommendation system and method has an effect of recommending customized/personalized contents for each user by actively utilizing the contents and user properties related to preference.

In addition, the present inventive concept has the effect of recommending contents in real-time by sharing the load by enabling a contents recommendation server and a contents recommendation client to perform training and recommendation, respectively.

To achieve the objectives, the present inventive concept provides a system for recommending contents based on a deep neural network, comprising: a drafted data generation unit configured to generate a contents drafted data and a user drafted data for each user for a plurality of contents; a contents feature extracting unit configured to extract respective contents features for the plurality of contents by inputting the contents drafted data for each user into an encoder; and a user preference prediction unit configured to restore the contents drafted data of a specific user by inputting the contents features for the specific user into a decoder, and predict a preference of the specific user for the plurality of contents by using the restored contents drafted data and the user drafted data of the specific user; wherein a contents is recommended according to the predicted preference.

Wherein the contents drafted data comprises a director drafted data, an actor drafted data, a genre drafted data, and a story drafted data, and the user drafted data comprises a popularity drafted data for the plurality of contents and a user weight drafted data for at least one of a director, an actor, a genre, a story, and a popularity.

Wherein the director drafted data configured to be generated by matrix decomposition and weighted matrix conversion applying a director weight to a director data, and wherein the director weight is assigned to each director according to a user evaluation data for the director and an importance of the director, the actor drafted data configured to be generated by matrix decomposition and weighted matrix conversion applying an actor weight to an actor data, wherein the actor weight is assigned to each actor according to a user evaluation data for the actor and an importance of the actor, the genre drafted data configured to be generated by vectorizing a genre data by performing TF-IDF for the genre data, and the story drafted data configured to be generated by vectorizing words by performing TF-IDF for the words appearing three or more times in a story data of all contents, after removing symbols, numbers, special characters, and person names from the story data.

Wherein the popularity drafted data configured to be generated by clustering a plurality of contents by release year, setting a ranking for the clusters by year based on the number of user evaluations, and normalizing the ranking, the user weighted drafted data for the director, the actor, the genre, the story, and the popularity configured to be generated by converting to respective weighted matrix by applying the user evaluations for the director, the actor, the genre, the story, and the popularity to the director data, the actor data, the genre drafted data, the story drafted data, and the popularity drafted data, respectively, calculating a variation coefficient within each of the matrices, and normalizing the variation coefficient, and the user weight drafted data for contents configured to be generated by combining user evaluations for the plurality of content and decomposing each of the matrices.

In addition, the system further comprises: a learning model generation unit configured to generate a learning model comprising: an encoder configured to train the generated contents drafted data for each user and output compressed contents features for the plurality of contents, a decoder configured to restore the contents drafted data by using the compressed contents features, and a user preference prediction model for predicting a user preference of each user for the plurality of contents by using the restored contents drafted data and the generated user drafted data for each user.

Wherein the user preference prediction unit further configured to predict the preference of the specific user by inputting the restored contents drafted data and the user drafted data of the specific user to the user preference prediction model.

In addition, the system further comprises: a clustering unit configured to cluster the plurality of contents into a plurality of clusters by calculating a similarity of each of the properties for the plurality of contents, wherein the system configured to input the user drafted data, the contents features, and a representative vector for each of the clusters into the user preference prediction model, predict the preference of each user for each cluster, rank the preference, and then recommend contents comprised in clusters with a higher rank than a preset rank.

In addition, the system further comprises: a contents recommendation client comprising the user preference prediction unit; and a contents recommendation server comprising the drafted data generation unit and the contents feature extraction unit.

Moreover, a method for recommending contents based on deep neural network in accordance with the present inventive concept, comprising: in a contents recommendation server, generating a contents drafted data and a user drafted data for each user for a plurality of contents; in the contents recommendation server, extracting respective contents features for the plurality of contents by inputting the contents drafted data for each user into an encoder; and in a contents recommendation client, restoring the contents drafted data of a specific user by inputting the contents features for the specific user into a decoder, predicting a preference of the specific user for the plurality of contents by using the restored contents drafted data and the user drafted data of the specific user, and thus recommending contents according to the predicted preference.

In addition, the method further comprises: in the contents recommendation server, generating a learning model comprising: an encoder configured to train the generated contents drafted data for each user and output compressed contents features for the plurality of contents, a decoder configured to restore the contents drafted data by using the compressed contents features, and a user preference prediction model for predicting a user preference of each user for the plurality of contents by using the restored contents drafted data and the generated user drafted data for each user; and in the contents recommendation server, providing the generated decoder and the user preference prediction model to the contents recommendation client.

Wherein the predicting of the preference of the user is to predict the preference of the specific user by inputting the restored contents drafted data and the user drafted data of the specific user to the user preference prediction model.

In addition, the method further comprises: in the contents recommendation server, clustering the plurality of contents into a plurality of clusters by calculating a similarity of each of the properties for the plurality of contents; and in the contents recommendation client, inputting the user drafted data, the contents features, and a representative vector for each of the clusters into the user preference prediction model, predict the preference of each user for each cluster, rank the preference, and then recommend contents comprised in clusters with a higher rank than a preset rank.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a conceptual diagram illustrating a deep neural network-based contents recommendation system and method in accordance with an embodiment of the present inventive concept.

FIG. 2 is a diagram illustrating a process of generating a director drafted data and an actor drafted data in accordance with an embodiment of the present inventive concept.

FIG. 3 is a diagram illustrating a process of generating a genre drafted data and a story drafted data in accordance with an embodiment of the present inventive concept.

FIG. 4 is a diagram illustrating a process of generating a popularity drafted data in accordance with an embodiment of the present inventive concept.

FIG. 5 is a diagram illustrating a process of generating a user weight drafted data for a director, an actor, a genre, a story, and a popularity in accordance with an embodiment of the present inventive concept.

FIG. 6 is a diagram illustrating a process of generating a user weight drafted data for contents in accordance with an embodiment of the present inventive concept.

FIG. 7 is a diagram illustrating a learning model in accordance with an embodiment of the present inventive concept.

FIG. 8 is a diagram illustrating an encoder in accordance with an embodiment of the present inventive concept.

FIG. 9 is a diagram illustrating a decoder and a user prediction model in accordance with an embodiment of the present inventive concept.

FIG. 10 is a diagram illustrating a process of clustering a plurality of contents in accordance with an embodiment of the present inventive concept.

FIG. 11 is a diagram illustrating a process of recommending contents by a contents recommendation client in accordance with an embodiment of the present inventive concept.

FIG. 12 is a block diagram illustrating a configuration of a contents recommendation client in accordance with an embodiment of the present inventive concept.

FIG. 13 is a block diagram illustrating a configuration of a contents recommendation server in accordance with an embodiment of the present inventive concept.

FIG. 14 is a flowchart illustrating a procedure for recommending contents in accordance with an embodiment of the present inventive concept.

### DETAILED DESCRIPTION OF THE EMBODIMENTS

Hereinafter, preferred embodiments of the present inventive concept, the deep neural network-based contents recommendation system and method, is described in detail with reference to accompanying drawings. The same reference numeral presented in each drawing indicates the same element. In addition, specific structural or functional descriptions for the embodiments of the present inventive concept are only exemplified for the purpose of describing the embodiments according to the present inventive concept, and unless defined differently, all terms used herein this document, including technical or scientific terms have the same meaning as commonly understood by a person of ordinary skilled in the art to which the present inventive concept belongs. Terms such as those defined in a commonly used dictionary should be interpreted as having the meaning which is consistent with the meaning in the context of the related arts and it is desirable that they should not be over-interpreted as to an ideal or excessively formal meaning, unless explicitly defined in the present specification. In the present inventive concept, data can be interpreted as digital information.

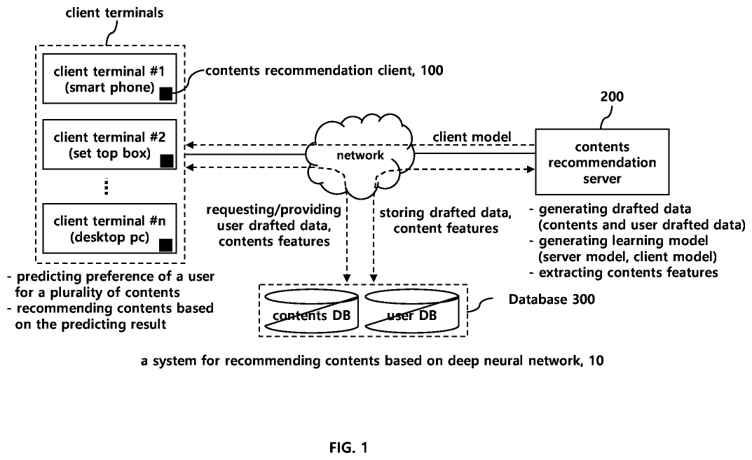

FIG. 1 is a conceptual diagram illustrating a deep neural network-based contents recommendation system and method in accordance with an embodiment of the present inventive concept.

As shown in FIG. 1, the deep neural network-based contents recommendation system 10 in accordance with an embodiment of the present inventive concept comprises a contents recommendation client 100, a contents recommendation server 200 and a database 300.

The contents recommendation client 100 is provided in each user's client terminal and performs a function of recommending contents to a corresponding user.

Here, the client terminal means a user device for consuming content, such as a smart phone, a set-top box, and a desktop PC, etc.

In addition, the contents recommendation client 100 is configured to be mounted on the client terminal in the same form as an application program.

In this case, the user downloads the contents recommendation client 100 from the contents recommendation server 200 that provides the contents recommendation client 100 to the client terminal and installs the downloaded contents recommendation client 100, executes the installed contents recommendation client 100, and thus can utilize the contents recommendation client 100.

In addition, recommending contents is performed by using a learning model generated through training in the contents recommendation server 200.

The contents recommendation server 200 generates a contents drafted data and a user drafted data for a plurality of users by using each of contents data for a plurality of contents stored in the database 300 for the training and a user evaluation data for each user.

Wherein the drafted data is input data that have been appropriately selected and processed to meet the goals of the system and is updated while continuously reflecting user preferences along with the training of the parameters for a learning model.

In addition, the learning model comprises a server model comprising an encoder and a client model comprising a decoder and a user preference prediction model. In addition, the encoder is configured to train contents drafted data for a plurality of users and output contents features for a plurality of contents.

The decoder is configured to restore contents drafted data from the contents features, and the user preference prediction model comprises a deep neural network for predicting the preference of the user for the contents features by training the restored contents drafted data and user drafted data.

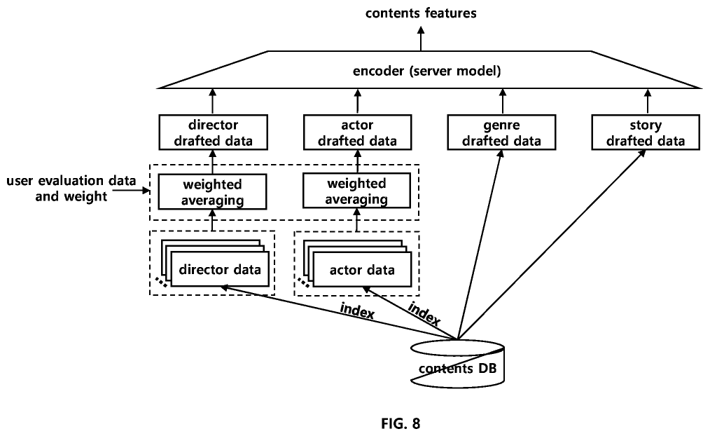

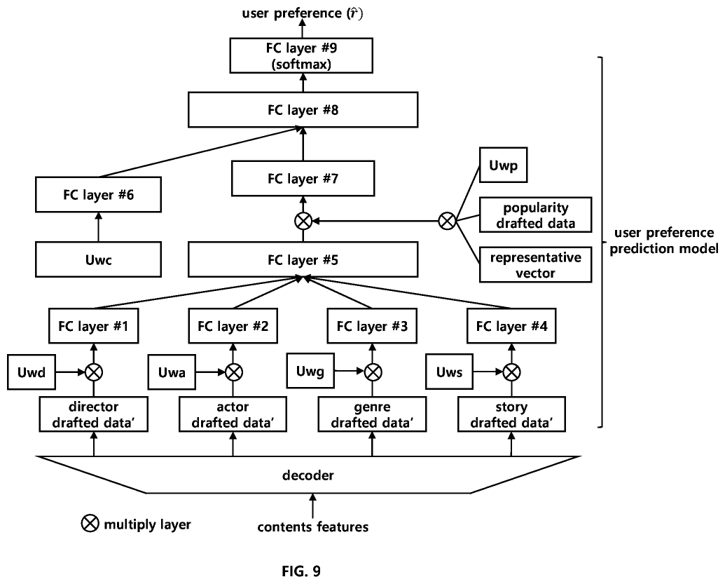

Meanwhile, the learning model will be described in detail with reference to FIG. 8 and FIG. 9.

The contents recommendation server 200 provides a client model to each of the contents recommendation client 100, so that each of the contents recommendation client 100 can continuously recommend contents to each user.

That is, the deep neural network-based contents recommendation system 10 of the present inventive concept is configured to respectively share the training function and contents recommendation function to the contents recommendation server 200 and the contents recommendation client 100.

The contents drafted data and user drafted data are generated through contents data that describes contents and user evaluation data that explicitly expresses user preferences.

In addition, the contents data comprises a director data on the director who produced the contents, an actor data on the actors who participated in the contents, a genre data indicating the genre of the contents, a story data indicating the story of the contents, and a popularity data indicating the popularity of the contents.

In addition, the director data is configured to be arranged in order according to the importance of a plurality of directors (e.g., a main director, an assistant director, a camera director, etc.) participating in contents production. For example, if the importance is in the order of the main director, the assistant director, and the camera director, the director data is configured to be arranged in the order of the main director, the assistant director, and the camera director.

In addition, the actor data is configured to be arranged in order according to the importance of a plurality of actors (e.g., a leading actor (a featured actor), a supporting actor, a cameo, a minor actor (or an extra), etc.) participating in the contents. For example, if the importance is in the order of a leading actor, a supporting actor, a cameo, and a minor actor, the actor data is configured to be arranged in the order of the leading, the supporting, the cameo, and the extra.

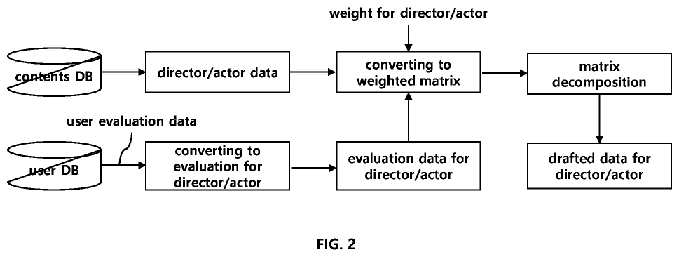

The contents drafted data comprises a director drafted data, an actor drafted data, a genre drafted data, and a story drafted data, and these are generated using a contents data and a user evaluation data, which are described in detail with reference to FIG. 2 to FIG. 5.

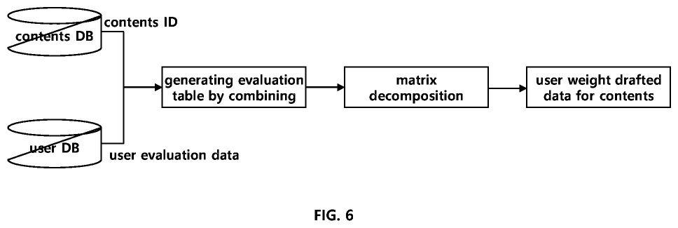

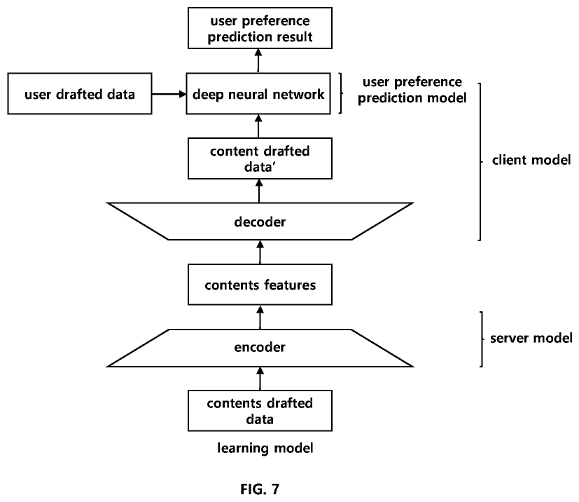

The user drafted data comprises a popularity drafted data and a weight drafted data for a plurality of contents, and a weight drafted data for at least one of a director, an actor, a genre, a story, and a recognition, which are described in detail with reference to FIG. 6 and FIG. 7.

The contents recommendation server 200 inputs contents drafted data for each user into the server model, so that it extracts contents features and stores the extracted contents features in the database 300.

When the contents recommendation client 100 recommends contents for a user (i.e., the owner of the client terminal), it requests and receives a user drafted data and contents features for the user from the database 300.

The contents recommendation client 100 predicts the preference of the user for a plurality of contents by using the user drafted data, the contents features, and the client model.

The contents recommendation client 100 determines a ranking for a plurality of contents according to the predicted result of the preference of the user, and then recommends contents which is ranked above a preset rank to the corresponding user.

At this time, the contents features are extracted and stored whenever the learning model is updated.

The contents recommendation server 200 updates the learning model when a new user subscribes, a new contents is registered, or a contents drafted data and a user drafted data for an individual user are updated (changed). In this case, the contents recommendation server 200 provides learning parameters for the updated client model to each of the contents recommendation client 100.

The database 300 is constructed in the form of a server (not just storage) such as a cloud DB that can transmit and receive data and comprises a contents database and a user database. The contents database stores a plurality of contents and contents data for each of the contents, and the user database stores a contents drafted data for each user, a user drafted data, a user evaluation data, contents features, and the like.

FIG. 2 is a diagram illustrating a process of generating a director drafted data and an actor drafted data in accordance with an embodiment of the present inventive concept.

As shown in FIG. 2, the contents recommendation server 200 according to an embodiment of the present inventive concept requests director and actor data and user evaluation data to the database 300 and receives them from the database 300 to generate a director drafted data and an actor drafted data.

The director data and actor data are extracted from contents data, wherein an identifier for each director and actor is assigned.

On the other hand, since the user tends to give a high rating to the contents according to the importance of the director and the actor, the contents recommendation server 200 assigns weights (director/actor weights) according to the importance of the director and actor in the director and actor data for the purpose of reflecting the tendency for recommending the contents.

That is, higher weights are assigned to directors and actors with higher importance, and relatively lower weights are assigned to directors and actors with relatively lower importance.

In this case, since the director and the actor data are respectively arranged in order according to their importance in the director data and the actor data, the contents recommendation server 200 allocates weights to the director and the actor according to the arranged order, respectively.

The contents recommendation server 200 extracts the evaluation scores for the directors and the actors from the user rating data stored in the user database, respectively, and converts them into evaluation scores for the director and the actor, respectively.

The conversion to the evaluation scores for the director and actor is performed by mapping each of the identifiers for the corresponding director and actor with the evaluation scores for each of the director and actor.

The contents recommendation server 200 generates user evaluation data for each of the director and the actor by using the mapping result. The user evaluation data for each of the director and the actor is performed by transforming the mapping result into a matrix.

The contents recommendation server 200 generates an m x n type of director matrix for all directors indexed with the identifiers for each director with reference to the director data.

The contents recommendation server 200 creates an actor matrix in the form of m x n for all actors indexed with identifiers for each actor with reference to the actor data.

The contents recommendation server 200 converts a director matrix to the weighted director matrix by reflecting the evaluation score and director weight for each director to the director matrix with reference to the user evaluation data for each of the directors.

The contents recommendation server 200 converts an actor matrix into a weighted actor matrix by reflecting the evaluation score and weight for each actor to the actor matrix with reference to the user evaluation data for each of the actors.

The reflecting the evaluation score is to give an evaluation score for each of directors or actors to the director matrix and the actor matrix with reference to the user evaluation data.

In addition, the converting to a weighted matrix is to normalize the director matrix and the actor matrix with row by row, which is performed by dividing each value in the row by the result of adding up all the values in the row.

The contents recommendation server 200 performs matrix decomposition on the weighted director matrix and the weighted actor matrix, respectively, so that it can generates a director drafted data and an actor drafted data for each user and then store them in the user database.

The matrix decomposition is performed through the Truncated-SVD (singular value decomposition) method, and the contents recommendation client 100 decomposes the weighted director matrix and the actor matrix through the following [Equation 1].

a=UΣV^{T} [Equation 1]

Here, A denotes a weighted matrix (a director matrix, an actor matrix), U denotes an m×m orthogonal matrix obtained through eigen decomposition of AA^{T}, and V denotes an n×n matrix obtained through eigen decomposition of A^{T}A. Also, Σ denotes a diagonal matrix in the form of m×n, in which the diagonal elements are the square roots of the eigenvalues of U and V. In this case, in the diagonal matrix, elements other than diagonal elements have a value of 0. Wherein, m, n have values of positive integers.

Next, the contents recommendation server 200 removes all 0's from the diagonal matrix, and also removes all elements of U and V corresponding to the removed part of the diagonal matrix, so that the dimension of the decomposition result could be reduced.

That is, the contents recommendation server 200 converts the user evaluation data and the weights for the director and the actor into a weighted matrix by reflecting the user evaluation data for a director and an actor and the weights for the director and the actor assigning each of the director and the actor to the director data and the actor data, respectively, and generates a director drafted data and an actor drafted data by compressing the weighted matrix through the matrix decomposition for the weighted matrix.

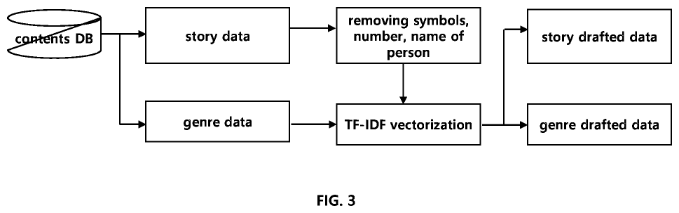

FIG. 3 is a diagram illustrating a process of generating a story drafted data and a genre drafted data in accordance with an embodiment of the present inventive concept.

As shown in FIG. 3, in order to generate the story drafted data and the genre drafted data according to an embodiment of the present inventive concept, the contents recommendation server 200 requests the story data and the genre data to the database 300 and receives them from the database 300.

In this case, the story data and the genre data are extracted from the contents data stored for each of the contents.

In addition, the contents recommendation server 200 generates a story drafted data and a genre drafted data by vectorizing the story data and genre data through TF-IDF (term frequency-inverse document frequency) and converting them into matrices, respectively.

In addition, when the contents recommendation server 200 vectorizes the story data, it removes numbers, symbols, and names of people that are not related to the story and performs TF-IDF only for words that appear three or more times in the story data of all contents.

TI-IDF is a type of count-based feature extraction technique that converts text data into a computer-recognizable real number vector according to the frequency of each word appearing in multiple documents, and thus it is commonly used to vectorize multiple documents. So, a detailed description thereof is skipped.

Meanwhile, each word appearing in the story data and genre data is vectorized by aligning in ascending or descending order.

In addition, the story drafted data and genre drafted data are generated and stored by each of the contents.

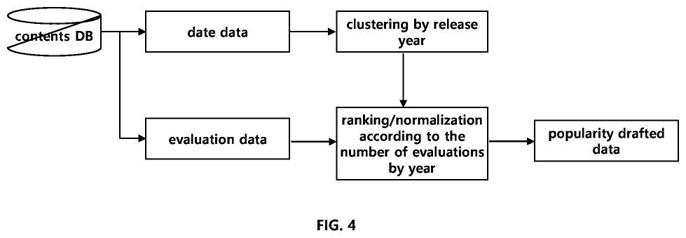

FIG. 4 is a diagram illustrating a process of generating a popularity drafted data in accordance with an embodiment of the present inventive concept.

As shown in FIG. 4, the contents recommendation server 200 according to an embodiment of the present inventive concept requests the user evaluation data and the date data to the contents database and is provided them from the contents database for generating the popularity drafted data. The date data indicates the date when each of the contents is released. And the date data is extracted and provided from the contents data in the contents database.

Here, the user evaluation data for each of the contents means an evaluation score presented by the user for each of the contents.

The contents recommendation server 200 clusters a plurality of contents by release year with reference to the date data.

The contents recommendation server 200 sets the ranking by year according to the number of evaluations for each year based on the number of evaluations of the user with referring to the evaluation data of the user for the contents.

The contents recommendation server 200 normalizes the set ranking by year and transforms it into a matrix, so that it can generate a popularity drafted data for each user.

In other words, the popularity drafted data does not mean the popularity of each of the contents, but rather the preference of the user for the contents production era for the year when the contents is produced.

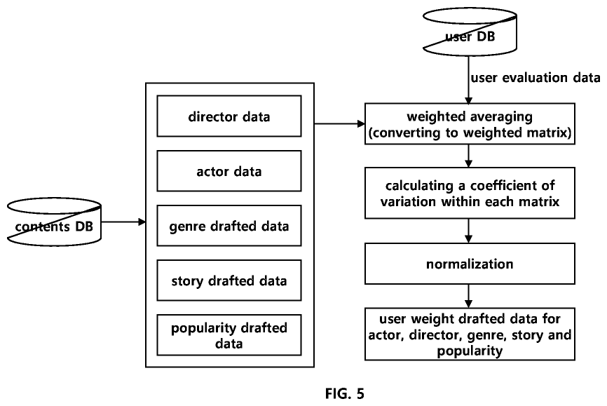

FIG. 5 is a diagram illustrating a process of generating weight drafted data for a director, an actor, a genre, a story, and a popularity in accordance with an embodiment of the present inventive concept.

As shown in FIG. 5, the user weight drafted data according to an embodiment of the present inventive concept is generated as data in the form of a weight respectively related to each of the contents drafted data by using the user evaluation data and the contents drafted data for a plurality of contents.

The user weight drafted data comprises a user weight drafted data for each of a director, an actor, a genre, a story, and a popularity.

The user weight drafted data for directors and actors is generated by using director and actor data (embedding vectors), and the user weight drafted data for the remaining genres, story and popularity is generated by using a genre drafted data, a story drafted data, and a popularity drafted data.

The contents recommendation server 200 generates a weighted director matrix and an actor matrix through performing weighted averaging by reflecting user evaluation score and the director weight and the actor weight assigning to each of the director and the actor to the director data and the actor data.

The contents recommendation server 200 generates a weighted genre matrix, story matrix and popularity matrix respectively by performing weight averaging with reflecting an evaluation score on the genre, an evaluation score on the story, and an evaluation score on the popularity to the genre drafted data, the story drafted data, and the popularity drafted data with reference to the user evaluation data.

On the other hand, the evaluation score for the genre is a score presented according to the preference of the user for a plurality of genres, and the evaluation score for the story is a score presented according to the preference of the user for each word used in the story. In addition, the evaluation score for the popularity is a scored by a ranking by year with referring to the evaluation score presented to the contents.

In addition, since the generation of the weighted matrix is described with reference to FIG. 2, further detailed description will be skipped.

The contents recommendation server 200 generates a user weighted drafted data for each of the director, the actor, the genre, the story, and the popularity by calculating a coefficient of variation within each of the weighted matrices and normalizing each element in the weighted matrices with the coefficient of variation.

The coefficient of variation is the ratio of the standard deviation to the mean, and thus is calculated by dividing the standard deviation by the mean. In addition, the coefficient of variation in the present inventive concept, is used for more appropriately detecting the bias extracted by the outliers without being affected by the scale between the features (a director, an actor, a genre, a story, a popularity, etc.) of each of the contents. By using the coefficient of variation in this way, the bias toward outliers can be more evenly obtained.

FIG. 6 is a diagram illustrating a process of generating a user weight drafted data for contents in accordance with an embodiment of the present inventive concept.

As shown in FIG. 6, the contents recommendation server 200 according to an embodiment of the present inventive concept requests and receives an identifier and user evaluation data for each of the contents to/from the database 300, and extracts user evaluation (score) on each of the contents from the user evaluation data.

The contents recommendation server 200 generates an evaluation table by combining the identifier and the user evaluation score for each of the contents. In this case, it may be set to 0 for the contents without user evaluation.

The contents recommendation server 200 converts the evaluation table into a weighted matrix and then performs matrix decomposition to generate a user weighted drafted data for the contents.

Meanwhile, since converting to the weighted matrix and performing matrix decomposition have been described with reference to FIG. 2, further detailed descriptions will not be needed.

FIG. 7 is a diagram illustrating a learning model in accordance with an embodiment of the present inventive concept.

As shown in FIG. 7, the learning model according to an embodiment of the present inventive concept is generated by training contents drafted data and user drafted data for a plurality of users, and a server model comprising an encoder, and a client model comprising a decoder and a user preference prediction model.

The output of the encoder is configured to be the input of the decoder, and the output of the decoder is configured to be the input of the user preference prediction model.

The encoder is configured to train the contents drafted data for a plurality of users and output the contents features for a plurality of contents.

The decoder is configured to restore the contents drafted data by utilizing the contents features.

In addition, the user preference prediction model is configured to predict the preference of the user by training the restored contents drafted data and user drafted data for a plurality of users.

Meanwhile, as described above, the client model is provided to each of the contents recommendation client 100.

The contents recommendation server 200 updates the learning model by reflecting what a new user joins, new contents is registered, or contents drafted data and user drafted data for each user are changed. In addition, when the learning model is updated, the contents recommendation server 200 provides learning parameters for the decoder and the user preference prediction model to each of the contents recommendation client 100 so that they can be updated.

The encoder is described in detail with reference to FIG. 8, and the decoder and the user preference prediction model are described in detail with reference to FIG. 9.

FIG. 8 is a diagram illustrating an encoder in accordance with an embodiment of the present inventive concept.

As shown in FIG. 8, the input of the encoder according to an embodiment of the present inventive concept is the contents drafted data for a user, and the output of the encoder is contents features for a plurality of contents.

Accordingly, the contents recommendation server 200 inputs the contents drafted data for each user to the encoder to extract the contents features, and stores the extracted contents features in a contents database.

Meanwhile, since the process of generating the contents drafted data is described with reference to FIGS. 2 and 3, further detailed description will be skipped here.

Wherein the weighted averaging through the user evaluation data is a process of performing weighted averaging with reflecting the weights of the director and the actor, which are assigned to each in the specified order to reflect the tendency that the actors and directors (such as lead or main actors and directors, etc.) indicated in the front play more important roles, when there are multiple actors and directors.

FIG. 9 is a diagram illustrating a decoder and a user prediction model according to an embodiment of the present inventive concept.

As shown in FIG. 9, when the contents recommendation client 100 according to an embodiment of the present inventive concept recommends contents to a specific user, it requests the user drafted data and contents features for the specific user to the database 300, and is provided them from the database 300 (via accessing them from the database), then it inputs the contents features to the decoder, so that it restores the contents drafted data for the user via the decoder.

At this time, the restored contents drafted data (a director drafted data′, an actor drafted data′, a genre drafted data′, a story drafted data′) are decompressed data that approximate the original contents drafted data (contents drafted data stored in the database).

The contents recommendation client 100 predicts the preference of the user for a plurality of contents by inputting the restored contents drafted data and the user drafted data into the user preference prediction model and performs the function that recommends the contents to the user according to the result of prediction for the preference of the user.

The user preference prediction model is configured to comprise a plurality of fully connected (FC) layers and a plurality of multiply layers.

As shown in FIG. 9, each multiply layer with the contents drafted data and the user weight drafted data as inputs extracts U and V representing the eigen values of the contents drafted data and multiplies them with the user weight drafted data. The FC layers (FC layer #1 to FC layer #4) with the outputs of the multiply layers as inputs outputs by fully connecting with the elements of U and V of the corresponding contents drafted data.

Meanwhile, Uwd, Uwa, Uwg, and Uws shown in FIG. 9 represent a user weight drafted data for a director, a user weight drafted data for an actor, a user weight drafted data for a genre, and a user weight drafted data for a story.

In addition, the FC layer #5 outputs by fully connecting the results of the previous FC layers (FC layer #1 to FC layer #4).

In addition, FC layer #6 with the user weight drafted data (Uwc) for contents as inputs, outputs by fully connecting U and V representing the eigen values of the corresponding drafted data.

In addition, the multiply layers with the user weight drafted data (Uwp) for popularity, the popularity drafted data and representative vector as inputs multiply U and V representing the eigen values of the corresponding user weight drafted data by U and V representing the eigen values of the popularity drafted data, and outputs the results multiplying the multiplication results by the representative vector.

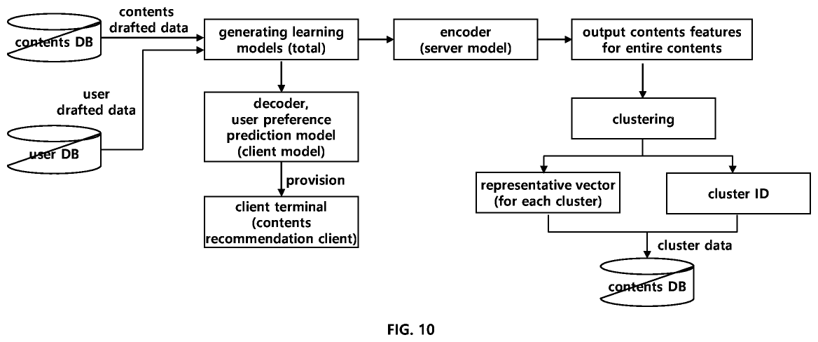

On the other hand, the representative vector is a central vector for each of clusters clustering a plurality of contents into a plurality of clusters according to the contents features outputted from the contents recommendation server 200, and the representative vector is described with reference to FIG. 10.

In addition, the multiply layers located between FC layer #5 and FC layer #7 output by multiplying the output result of the FC layer #5 and the output result of the previous multiply layers.

In addition, the FC layer #7 outputs by fully connecting the output result of the multiply layers located between the FC layer #5 and the FC layer #7.

In addition, the FC layer #8 outputs by fully connecting the output results of the previous FC layers (FC layer #6 and FC layer #7), and the FC layer #9 outputs by fully connecting the output result of the FC layer #8 and outputs the preferences of the user for a plurality of contents through a Softmax.

That is, the FC layer performs a function of compressing or expanding at least one or more input data by connecting the at least one or more input data and performs a function of multiplying at least one or more input data and outputs the multiplication results.

FIG. 10 is a diagram illustrating a process of clustering a plurality of contents in accordance with an embodiment of the present inventive concept.

As shown in FIG. 10, the contents recommendation server 200 according to an embodiment of the present inventive concept generates a learning model by training the contents drafted data and the user drafted data for a plurality of users stored in the contents database and the user database.

The contents recommendation server 200 provides a client model to a contents recommendation client, wherein the client model comprises a decoder and a user preference prediction model among the learning models.

The contents recommendation server 200 inputs contents drafted data for each user to the encoder to extract contents features for the entire contents for each user.

The contents recommendation server 200 calculates the similarity between the respective contents features for the entire contents and performs clustering a plurality of contents within a preset similarity range into a plurality of clusters according to the result of calculating the similarity.

The contents recommendation server 200 generates a representative vector and a cluster ID for each grouped cluster, generates a cluster data mapped to each cluster for each user, and then stores the generated cluster data to the contents database.

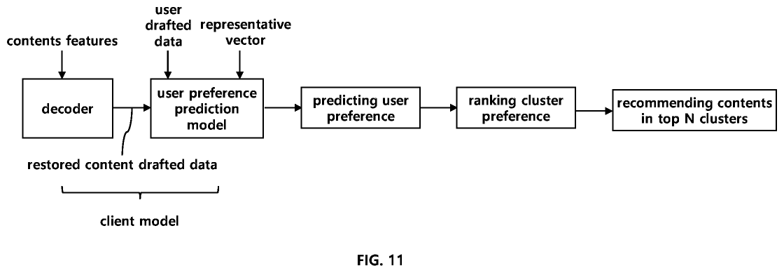

FIG. 11 is a diagram illustrating a process of recommending contents by a contents recommendation client in accordance with an embodiment of the present inventive concept.

As shown in FIG. 11, when the contents recommendation client 100 according to an embodiment of the present inventive concept recommends contents to a specific user, it requests the user drafted data, contents features, and representative vector for the user to the database 300, and the database 300 provides them to the contents recommendation client 100.

The contents recommendation client 100 also restores a contents drafted data for the user by inputting contents features to the decoder.

The contents recommendation client 100 predicts user preferences for a plurality of clusters by inputting the restored contents drafted data, the user drafted data, and the representative vector into the user preference prediction model.

The contents recommendation client 100 recommends contents included in the preset top N clusters by ranking preferences for the clusters according to the result of predicting user preferences for a plurality of clusters.

That is, the contents recommendation client 100 can continuously recommend contents to the user by using the client model received from the contents recommendation server 200 and user drafted data and contents features stored in the user database.

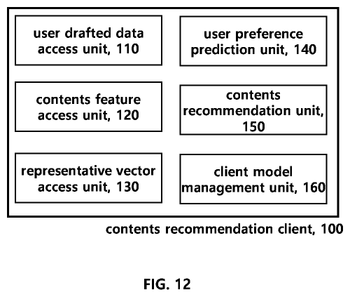

FIG. 12 is a block diagram illustrating the configuration of a contents recommendation client in accordance with an embodiment of the present inventive concept.

As shown in FIG. 12, the contents recommendation client 100 according to an embodiment of the present inventive concept is for recommending contents to a user and is configured to comprise a user drafted data access unit 110, a contents feature access unit 120, a representative vector access unit 130, a user preference prediction unit 140, a contents recommendation unit 150, and a client model management unit 160.

The user drafted data access unit 110 is configured to request and receive the user drafted data to/from the user database.

The contents feature access unit 120 is configured to request and receive the contents features to/from the user database.

The representative vector access unit 130 is configured to request and receive the representative vector for each cluster to/from the user database.

In other words, the units are configured to directly request and receive the data to/from the user database or request ant receive the data via the contents recommendation server. Here, both the words of request and receive are described in commonly called to access.

The user preference prediction unit 140 is configured to restore contents drafted data for the user by inputting the contents features received from the contents feature access unit 120 to the decoder of the client model.

In addition, the user preference prediction unit 140 is also configured to predict the preference of the user for a plurality of contents by respectively inputting the restored contents drafted data and the accessed user drafted data and the representative vector to the user preference prediction model of the client model. In this case, the predicted user preference is for a plurality of clusters.

The contents recommendation unit 150 is configured to recommend contents included in the cluster having a rank higher than or equal to a preset rank by ranking the preference for the cluster according to the result of predicting the preference of the user.

The client model management unit 160 is configured to store and manage the client model received from the contents recommendation server 200 in a memory (not shown).

The client model management unit 160 is configured to update the training parameters by reflecting the training parameters to the previous (existing) client model, when the learning model is updated in the contents recommendation server 200 and the training parameters are received for the client model.

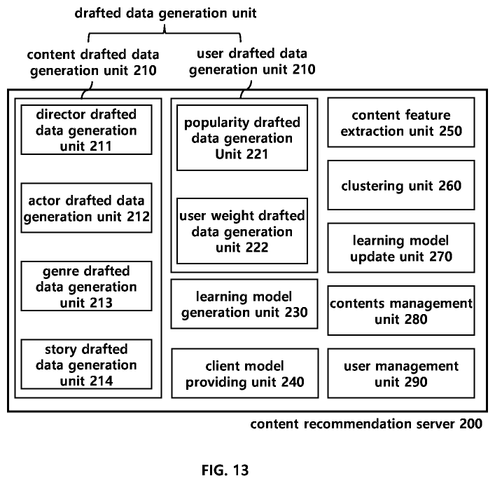

FIG. 13 is a block diagram illustrating the configuration of a contents recommendation server in accordance with an embodiment of the present inventive concept.

As shown in FIG. 13, the contents recommendation server 200 according to an embodiment of the present inventive concept is configured to comprise a drafted data generation unit comprising a contents drafted data generation unit 210 and a user drafted data generation unit 220, and a learning model generation unit 230, the client model providing unit 240, the contents feature extraction unit 250, a clustering unit 260, a learning model update unit 270, a contents management unit 280 and a user management unit 290.

Wherein, the contents drafted data generation unit 210 is configured to generate contents drafted data for each user for a plurality of contents and store the generated contents drafted data in the database 300 and is also configured to comprise a director drafted data generation unit 211, an actor drafted data generation unit 212, a genre drafted data generation unit 213 and a story drafted data generation unit 214.

The user drafted data generation unit 220 is configured to generate a user drafted data for each user for a plurality of contents and stores the generated user drafted data in the database 300, and also configured to comprise a popularity drafted data generation unit 221 and a user weight drafted data generation unit 222 generating each user weight drafted data for a director, an actor, a genre, a story and a popularity and a user weight drafted data for contents.

Meanwhile, since generating of a contents drafted data and a user drafted data has been described with reference to FIGS. 2 to 6, further detailed description is skipped.

The learning model generation unit 230 is configured to generate a learning model by training the contents drafted data and user drafted data generated for a plurality of users.

In this case, as described above, the learning model comprises a server model comprising an encoder and a client model comprising a decoder and a user prediction model.

The client model providing unit 240 is configured to provide the client model to the contents recommendation client 100.

The contents feature extraction unit 250 is configured to extract contents features for a plurality of contents for each user by inputting the contents drafted data for each user into a server model(encoder) and store the extracted contents features in the database 300.

The clustering unit 260 is configured to calculate a similarity with respect to the contents features for the plurality of extracted contents and perform clustering the plurality of contents into a plurality of clusters.

Meanwhile, since the clustering is described with reference to FIG. 10, further detailed description will be skipped.

The learning model update unit 270 is configured to update the learning model when a contents drafted data and user drafted data for a new subscribed user are generated, a new contents is registered, or an existing user's contents drafted data and user drafted data is changed.

The learning model update unit 270 is configured to update, when the learning model is updated, the client model by providing the training parameters for the client model to the contents recommendation client 100.

The contents management unit 280 is configured to manage the registered contents and the contents data for the corresponding contents.

The user management unit 290 is configured to store and manage information (e.g., ID, password, etc.) of the registered user.

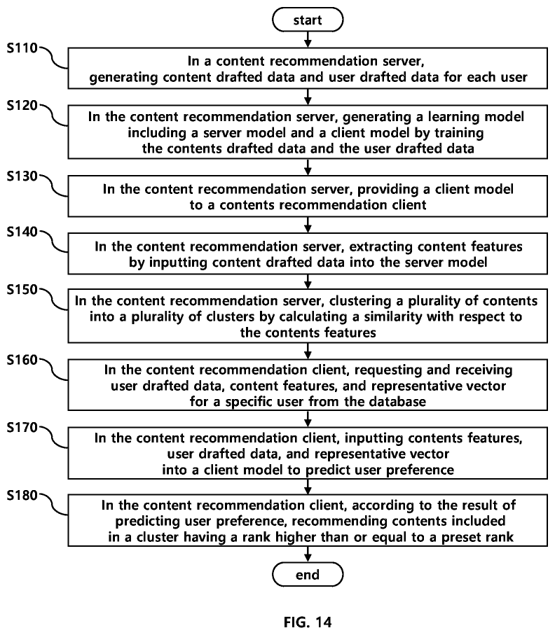

FIG. 14 is a flowchart illustrating a procedure for recommending contents in accordance with an embodiment of the present inventive concept.

As shown in FIG. 14, a processor to be configured to perform the process of recommending contents according to an embodiment of the present inventive concept, first, in the contents recommendation server 200 comprises generating a contents drafted data and a user drafted data for each user and storing the generated contents drafted data and user drafted data in the database 300 (S110).

Next, the process, in the contents recommendation server 200, comprises generating a learning model comprising a server model and a client model by training the contents drafted data and user drafted data for each user (S120).

Meanwhile, the generation of the contents drafted data and the user drafted data is described with reference to FIGS. 2 to FIG. 6, and the generation of the learning model is described with reference to FIGS. 10 and 13, so a further detailed description will be skipped.

Next, the process, in the contents recommendation server 200, comprises providing the client model among the learning models to a contents recommendation client by separating the generated learning models (S130).

That is, in the present inventive concept, a client model is provided in the contents recommendation client 100 and a server model is provided in the contents recommendation server 200, and thus the load for contents recommendation is shared or distributed between the contents recommendation client 100 and the contents recommendation server 200, so that it is possible to effectively recommend the contents.

Next, the process, in the contents recommendation server 200, comprises extracting contents features for a plurality of contents by inputting the contents drafted data into the server model, and storing the extracted contents features in the database 300 (S140).

Next, the process, in the contents recommendation server 200, comprises calculating the similarity for the contents features, generating cluster data by performing clustering a plurality of contents into a plurality of clusters, and then storing the cluster data in the database 300 (S150). Here, the cluster data comprises a representative vector and a cluster ID for each cluster.

Meanwhile, as described above, the contents features and the cluster data are generated for each user.

Since the clustering is described with reference to FIG. 10, further detailed description is skipped.

Next, the process, in the contents recommendation client 100, comprises requesting the user drafted data for a specific user, the contents features, and a representative vector for each cluster to the database 300, and obtaining the user drafted data, the contents features, and the representative vector from the database 300 (S160).

Next, the process, in the contents recommendation client 100, comprises predicting a user preference by inputting the user drafted data, the contents features, and the representative vector to the client model (S170).

In this case, predicting the preference of the user is to restore contents drafted data by inputting the contents features into a decoder of the client model, and to predict the preference of the user for a plurality of clusters by inputting the restored contents drafted data, the user drafted data, and a representative vector into the user preference prediction model of the client model.

Next, the process, in the contents recommendation client 100, comprises recommending a contents comprised in the cluster having rank higher than a preset rank according to a result of predicting user preference (S180).

The operations or steps of the methods or algorithms described above can be embodied as computer readable codes on a computer readable recording medium, or to be transmitted through a transmission medium. The computer readable recording medium is any data storage device that can store data which can be thereafter read by a computer system. Examples of the computer readable recording medium include read-only memory (ROM), random-access memory (RAM), compact disc (CD)-ROM, digital versatile disc (DVD), magnetic tape, floppy disk, and optical data storage device, not being limited thereto. The transmission medium can include carrier waves transmitted through the Internet or various types of communication channel. The computer readable recording medium can also be distributed over network coupled computer systems so that the computer readable code is stored and executed in a distributed fashion.

At least one of the components, elements, modules or units (collectively “components” in this paragraph) represented by a block in the drawings, such as the contents recommendation server 200 and the content recommendation client 100, and database 300, etc., in FIGS. 12 and 13 may be embodied as various numbers of hardware, software and/or firmware structures that execute respective functions described above, according to an exemplary embodiment. For example, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, although a bus is not illustrated in the above block diagrams, communication between the components may be performed through the bus. Functional aspects of the above exemplary embodiments may be implemented in algorithms that execute on one or more processors. Furthermore, the components represented by a block or processing steps may employ any number of related art techniques for electronics configuration, signal processing and/or control, data processing and the like.

As described above, the present inventive concept relates to a deep neural network-based contents recommendation system and a method therefor, and has the effect of recommending contents in real-time in that training to create a learning model for contents recommendation is performed in a contents recommendation server, and actual contents recommendation using the trained learning model is performed in the contents recommendation client,

In addition, the present inventive concept has the effect of providing a personalized contents recommendation service by recommending contents by reflecting both the contents features and the preference of the user.

While the preferred embodiment according to the present inventive concept has been mainly described in the above description, but the technical spirit of the present inventive concept is not limited thereto, and each component of the present inventive concept could be changed or modified within the technical scope of the present inventive concept to achieve the same purpose and effect.

In addition, although preferred embodiments of the present inventive concept are illustrated and described in the above description, the present inventive concept is not limited to the specific embodiments described above, and various modifications may also be made by an ordinary skilled person in the technical field to which the present inventive concept belongs without departing from the gist claimed in the claims of the present inventive concept, and these modifications should not be individually understood from the technical spirit or perspective of the present inventive concept. Therefore, the technical scope of the present inventive concept will be determined by the claims as follows.

What is claimed is:

1. A system for recommending contents based on a deep neural network, comprising:
a drafted data generation unit configured to generate a contents drafted data and a user drafted data for each user for a plurality of contents;
a contents feature extracting unit configured to extract respective contents features for the plurality of contents by inputting the contents drafted data for each user into an encoder; and
a user preference prediction unit configured to restore the contents drafted data of a specific user by inputting the contents features for the specific user into a decoder, and predict a preference of the specific user for the plurality of contents by using the restored contents drafted data and the user drafted data of the specific user;
wherein a contents is recommended according to the predicted preference.

2. The system according to claim 1, wherein the contents drafted data comprises a director drafted data, an actor drafted data, a genre drafted data, and a story drafted data, and
the user drafted data comprises a popularity drafted data for the plurality of contents and a user weight drafted data for at least one of a director, an actor, a genre, a story, and a popularity.

3. The system according to claim 2, wherein the director drafted data configured to be generated by matrix decomposition and weighted matrix conversion applying a director weight to a director data,
wherein the director weight is assigned to each director according to a user evaluation data for the director and an importance of the director,
the actor drafted data configured to be generated by matrix decomposition and weighted matrix conversion applying an actor weight to an actor data, wherein the actor weight is assigned to each actor according to a user evaluation data for the actor and an importance of the actor,
the genre drafted data configured to be generated by vectorizing a genre data by performing TF-IDF for the genre data, and
the story drafted data configured to be generated by vectorizing words by performing TF-IDF for the words appearing three or more times in a story data of all contents, after removing symbols, numbers, special characters, and person names from the story data.

4. The system according to claim 2, wherein the popularity drafted data configured to be generated by clustering a plurality of contents by release year, setting a ranking for the clusters by year based on the number of user evaluations, and normalizing the ranking,
the user weighted drafted data for the director, the actor, the genre, the story, and the popularity configured to be generated by converting to respective weighted matrix by applying the user evaluations for the director, the actor, the genre, the story, and the popularity to the director data, the actor data, the genre drafted data, the story drafted data, and the popularity drafted data, respectively, calculating a variation coefficient within each of the matrices, and normalizing the variation coefficient, and
the user weight drafted data for contents configured to be generated by combining user evaluations for the plurality of content and decomposing each of the matrices.

5. The system according to claim 1, the system further comprises:
a learning model generation unit configured to generate a learning model comprising:
an encoder configured to train the generated contents drafted data for each user and output compressed contents features for the plurality of contents,
a decoder configured to restore the contents drafted data by using the compressed contents features, and
a user preference prediction model for predicting a user preference of each user for the plurality of contents by using the restored contents drafted data and the generated user drafted data for each user.

6. The system according to claim 5, wherein the user preference prediction unit further configured to predict the preference of the specific user by inputting the restored contents drafted data and the user drafted data of the specific user to the user preference prediction model.

7. The system according to claim 6, the system further comprises:
a clustering unit configured to cluster the plurality of contents into a plurality of clusters by calculating a similarity of each of the properties for the plurality of contents,
wherein the system configured to input the user drafted data, the contents features, and a representative vector for each of the clusters into the user preference prediction model, predict the preference of each user for each cluster, rank the preference, and then recommend contents comprised in clusters with a higher rank than a preset rank.

8. The system according to claim 1, the system further comprises:
a contents recommendation client comprising the user preference prediction unit; and
a contents recommendation server comprising the drafted data generation unit and the contents feature extraction unit.

9. A method for recommending contents based on deep neural network, comprising:
in a contents recommendation server, generating a contents drafted data and a user drafted data for each user for a plurality of contents;
in the contents recommendation server, extracting respective contents features for the plurality of contents by inputting the contents drafted data for each user into an encoder; and
in a contents recommendation client, restoring the contents drafted data of a specific user by inputting the contents features for the specific user into a decoder, predicting a preference of the specific user for the plurality of contents by using the restored contents drafted data and the user drafted data of the specific user, and thus recommending contents according to the predicted preference.

10. The method according to claim 9, wherein the contents drafted data comprises a director drafted data, an actor drafted data, a genre drafted data, and a story drafted data, and
the user drafted data comprises a popularity drafted data for the plurality of contents and a user weight drafted data for at least one of a director, an actor, a genre, a story, and a popularity.

11. The method of claim 10, wherein the director drafted data configured to be generated by matrix decomposition and weighted matrix conversion applying a director weight to a director data,
wherein the director weight is assigned to each director according to a user evaluation data for the director and an importance of the director,
the actor drafted data configured to be generated by matrix decomposition and weighted matrix conversion applying an actor weight to an actor data, wherein the actor weight is assigned to each actor according to a user evaluation data for the actor and an importance of the actor,
the genre drafted data configured to be generated by vectorizing a genre data by performing TF-IDF for the genre data, and
the story drafted data configured to be generated by vectorizing words by performing TF-IDF for the words appearing three or more times in a story data of all contents, after removing symbols, numbers, special characters, and person names from the story data.

12. The method of claim 10, wherein the popularity drafted data configured to be generated by clustering a plurality of contents by release year, setting a ranking for the clusters by year based on the number of user evaluations, and normalizing the ranking,
the user weighted drafted data for the director, the actor, the genre, the story, and the popularity configured to be generated by converting to respective weighted matrix by applying the user evaluations for the director, the actor, the genre, the story, and the popularity to the director data, the actor data, the genre drafted data, the story drafted data, and the popularity drafted data, respectively, calculating a variation coefficient within each of the matrices, and normalizing the variation coefficient, and
the user weight drafted data for contents configured to be generated by combining user evaluations for the plurality of content and decomposing each of the matrices.

13. The method of claim 9, the method further comprises:
in the contents recommendation server, generating a learning model comprising: an encoder configured to train the generated contents drafted data for each user and output compressed contents features for the plurality of contents, a decoder configured to restore the contents drafted data by using the compressed contents features, and a user preference prediction model for predicting a user preference of each user for the plurality of contents by using the restored contents drafted data and the generated user drafted data for each user; and
in the contents recommendation server, providing the generated decoder and the user preference prediction model to the contents recommendation client.

14. The method according to claim 13, wherein the predicting of the preference of the user is to predict the preference of the specific user by inputting the restored contents drafted data and the user drafted data of the specific user to the user preference prediction model.

15. The method according to claim 13, the method further comprises:
in the contents recommendation server, clustering the plurality of contents into a plurality of clusters by calculating a similarity of each of the properties for the plurality of contents; and
in the contents recommendation client, inputting the user drafted data, the contents features, and a representative vector for each of the clusters into the user preference prediction model, predict the preference of each user for each cluster, rank the preference, and then recommend contents comprised in clusters with a higher rank than a preset rank.
